(19) United States
(12) Patent Application Publication
(10) Pub. No.: US 2008/0154767 A1
(43) Pub. Date: Jun. 26, 2008

(54) METHOD FOR ASSESSING THE STRENGTH OF PATENT PORTFOLIOS AND VALUATING THEM FOR PURPOSES OF MONETIZATION

(76) Inventor: Richard J. D'Agostino, New York, NY (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/848,049

(22) Filed: Aug. 30, 2007

Related U.S. Application Data
(60) Provisional application No. 60/824,019, filed on Aug. 30, 2006.

(51) Int. Cl. G06Q 40/00

(52) U.S. Cl. 705/38

(57) ABSTRACT

Provided herein are methods of assessing patent portfolios to determine if they are loan-worthy assets and if they are found to be loan worthy, valuating the portfolios for purposes of monetizing them. Monetization of the patent portfolios will permit lending institutions to make loans using only the patent portfolios as collateral, or permit the transfer of the portfolio as an asset to another company after proper valuation.

### CROSS-REFERENCE TO RELATED APPLICATION DATA

This application claims priority to provisional application Ser. No. 60/824,019 filed Aug. 30, 2006, which application disclosure is incorporated herein by reference.

### FIELD OF THE INVENTION

The present invention relates generally to assessing the strength of patent portfolios and valuating patent portfolios to monetize them.

### BACKGROUND OF THE INVENTION

Traditionally, bank lenders have been reluctant to use as collateral anything other than hard (i.e., tangible) assets for a loan. For many companies today, their most valuable assets are their (intangible) intellectual property (“IP”) portfolios, and in particular, their patent portfolios. Lenders have traditionally been uncomfortable placing a value on a borrower's IP assets because of their institutional lack of experience in valuing IP assets, and the absence of established methodologies and standards to appraise and dispose of IP assets. As a result, very few loans are made by bank lenders based solely on a borrower's IP, despite the significant value of that IP.

In fact, in most instances IP portfolios as an asset are assigned a so-called “book value” (reflecting a value approximating the acquisition cost for the portfolio), and rolled in with a company's tangible assets as security (a “blanket lien”) when a lender makes a loan to a company. However, knowledge of the book value of an IP portfolio is essentially useless because it is irrelevant to the issue of whether the IP portfolio in and of itself is loan-worthy.

### SUMMARY

Provided herein are methods of assessing patent portfolios to determine if they are loan-worthy assets and if they are found to be loan worthy, valuating the portfolios for purposes of monetizing them. Monetization of the patent portfolios will permit lending institutions to make loans using only the patent portfolios as collateral, or permit the transfer of the portfolio as an asset to another company after proper valuation.

The above and other advantages of embodiments of this invention will be apparent from the following more detailed description when taken in conjunction with the accompanying drawings.

### BRIEF DESCRIPTION OF THE DRAWINGS

FIG. 1 shows a patent portfolio assessment summary according to an exemplary embodiment of the invention.

FIG. 2 shows patents plotted on a originality versus generality graph with a triage analysis according to an exemplary embodiment of the invention.

FIG. 3 shows patents plotted on a originality versus generality graph according to an exemplary embodiment of the invention.

FIG. 4 shows a table listing results of a patent strength test according to an exemplary embodiment of the invention.

FIGS. 5 and 6 show forward and backward citation records for Pat. Nos. 1, 2, and 6 according to an exemplary embodiment of the invention.

FIGS. 7 and 8 show forward citation records for Pat. Nos. 1 and 6 according to an exemplary embodiment of the invention.

FIG. 9 shows projected sales growth for a “tight quarters” scenario according to an exemplary embodiment of the invention.

FIG. 10 shows an exemplary IP owner's NPV product report for the “tight quarters” scenario according to an exemplary embodiment of the invention.

FIG. 11 shows an exemplary IP owner's NPV royalty report for the “tight quarters” scenario according to an exemplary embodiment of the invention.

FIG. 12 shows projected sales growth for a “breakout” scenario according to an exemplary embodiment of the invention.

FIG. 13 shows an exemplary IP owner's NPV product report for the “breakout” scenario according to an exemplary embodiment of the invention.

FIG. 14 shows an exemplary IP owner's NPV royalty report for the “breakout” scenario according to an exemplary embodiment of the invention.

### DETAILED DESCRIPTION

Described herein are innovative yet conservative methods for assessing patent portfolios to determine if they are loan-worthy assets (“Preliminary Portfolio Assessment”). Further, described herein are methods for valuating patent portfolios so that they may be monetized to reflect their revenue-generating potential, not merely assigned a book value. Also described is the need to assess how current social, economic, technological, legal, and cultural trends may impact the value of the patent portfolio.

Preliminary Portfolio Assessment (“PPA”)

A Preliminary Portfolio Assessment (“PPA”) should be conducted first to determine whether quantitative valuation of the patent portfolio is even warranted. This PPA is comprised of two parts: Patent Portfolio Assessment and Company Assessment.

Patent Portfolio Assessment

In the patent portfolio assessment, one considers several factors affecting the value of the patent portfolio for monetization purposes and assigns these factors either equal weights or different weights. The patent portfolio is then assigned a score for each factor. The patent portfolio is then assigned an overall score (reflecting all factors) on a scale between one (1) and one hundred (100). A minimum patent portfolio assessment score will permit further analysis of the portfolio to determine if it is loan-worthy.

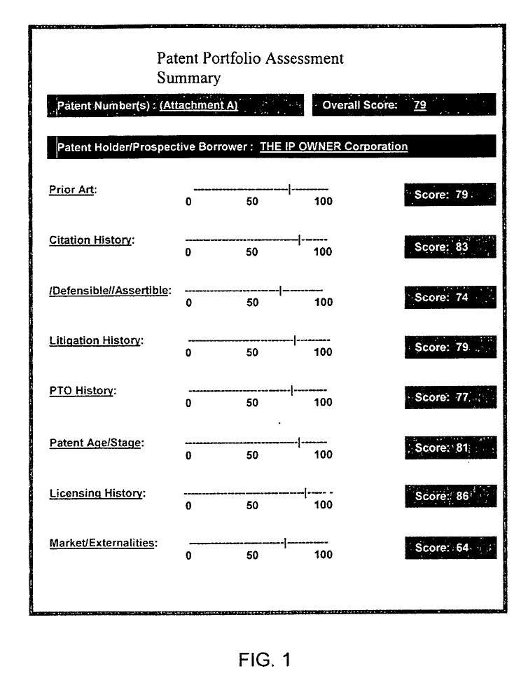

An exemplary Patent Portfolio Assessment for a fictional entity, the “IP Owner”, is described below. An examination of IP Owner's patents under a proprietary assessment and valuation methodology reveals substantial patent strength across segments of its patent holdings. Through utilization of the Patent Portfolio Assessment Summary (FIG. 1) as a front-end vehicle to establish the qualitative value of the IP Owner patent portfolio, the objective measure of value associated with the portfolio was determined to be 79 out of a possible score of 100.

Patent Analysis

Utilizing the structure for analysis and the principal value drivers employed in the Patent Portfolio Assessment included above (FIG. 1), the following analysis will attempt to explore the rationale and assumptions that underlie the patent portfolio assessment summary and provide a foundation upon which a formal quantitative valuation of the portfolio can be carried out.

Originality v. Generality Patent Analysis Test

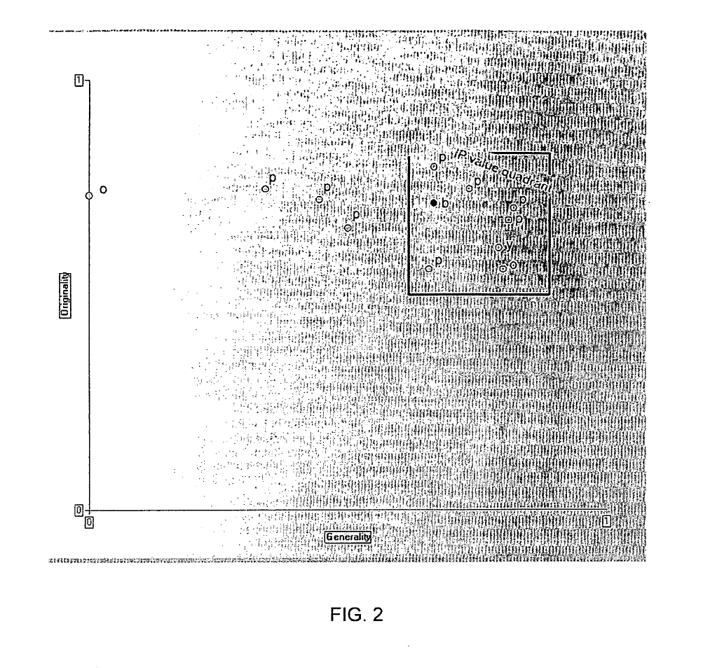

The first step in the process of analysis is to test IP Owner's portfolio for measures of originality. In a presently preferred embodiment, originality is measured by the breadth of backward citations (citations by the patent(s) to other patents and publications) across disciplines in the portfolio as represented by a diversity of Standard Industrial Classification (SIC) codes or National Bureau of Economic Research (NBER) codes. Generality is measured by the breadth and number of forward citations (patents and publications citing to the patent(s) in the portfolio). In general, patents with broader forward and backward citation scope (i.e., citations to patents and publications in a number of technical disciplines—physics, chemistry, materials science, electrical engineering, etc.) are more valuable than patents with narrowly defined citation scope. As such, IP Owner's patents were entered into the patent data analysis environment and sorted based on originality versus generality and viewed through a triage analysis to reveal those patents which offered the greatest potential value from the entire portfolio. The results of this triage analysis are included in FIG. 2.

In the analysis presented above in FIG. 2, a select group of 8 (eight) THE IP OWNER patents are identified as offering unique potential value relative to the other patents present in the total THE IP OWNER patent portfolio. These are the patents that scored the highest with regard to measures of generality and originality. The patents listed in the FIG. 2 appear in the form of colored dots. The colors represent the NBER Category Code associated with the particular patent. For example, the blue dot (“b”) indicates NBER Category 1—Chemical, the yellow dot (“y”) indicates NBER Category 5—Electrical and Electronics, the gold or orange appearing color (“o”) indicates NBER Category 5—Mechanical, and the pink dot (“p”) indicates NBER Category 6—Other. The “Other” category includes heating, pipes and joints, and a broad range of other industry subcategories.

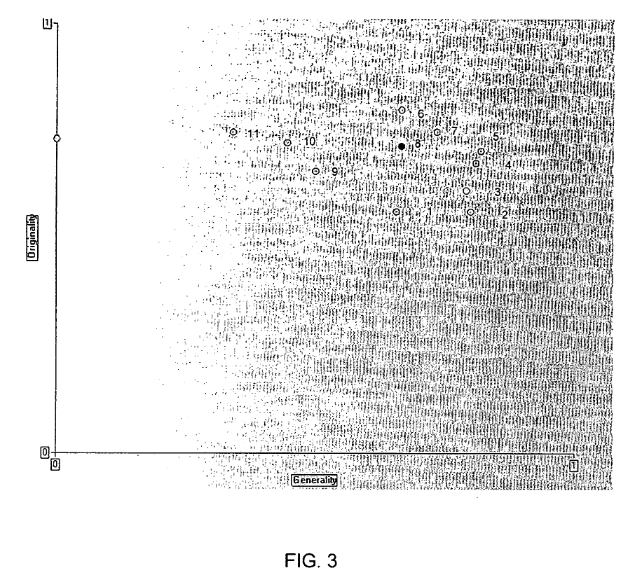

Due to the fact that the more complex patents of those categorized in the THE IP OWNER Value Quadrant in FIG. 3 above may be cited for more than one NBER code, it is important at this point to carefully review and analyze the patent claims and citations to ascertain which patents are part of common patent families of patents and prepare for onward valuation. Generally, the NBER code that predominates in terms of citation record dictates what color appears in the triage analysis graph. The triage depiction insofar as the NBER code identifiers are concerned is therefore only directionally relevant.

Further analysis of the patents contained in the FIG. 2, IP Owner's IP Value Quadrant of the Triage graph, reveals that three of the eight identified patents are part of the same family of fundamental inventions. Apparently originally drafted as a single patent and later divisionalized, these patents—Pat. Nos. 1, 2, and 6 are replete with method and apparatus claims directly related to a pad including a heat sink and thermal insulation areas that are broadly applicable across multiple fields of use including, but not limited to, automotive and white goods.

While the balance of the group of eight patents are, for the most part, patents that derive from the core patent claim coverage provided by the three fundamental patents identified above, the claims, claim structure, and citation history should allow one or more of these patents to serve as the patent backbone for a successor generation of IP Owner's products and/or licensing revenues. Given that these patents do not expire until the 2013-2017 period, their existence in the IP Owner Value quadrant and correlative overall strength should permit the extension of IP-supported product and royalty revenue beyond the 2010 expiry of Pat. Nos. 1, 2, and 6.

Important in their extension of the fundamental inventions claimed in these three patents and novel extensions of the overall category of thermal and acoustic insulation, these five patents are not only complementary to Pat. Nos. 3, 4 and 5, but also largely responsible for the advancement of emerging IP Owner's products (and resulting revenue streams).

Of these complementary patents, Pat. No. 8 stands out as offering the greatest potential financial value in the future and already is responsible (in combination with others in its family) for supporting products that generate approximately one-quarter of IP Owner's total annual revenue.

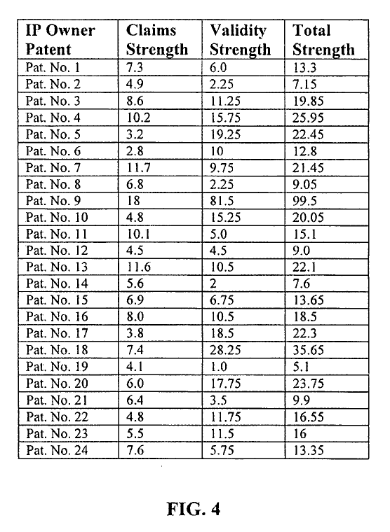

In order to ensure that the results of the generality versus originality test are validated and the patents of greatest potential significance and value are properly identified, a companion Patent Strength test was developed and employed to analyze IP Owner's Patent Portfolio; the results of which are included in FIG. 4. The bases for the calculations in FIG. 4 are given in Appendix A and B. The patents highlighted in yellow are those that were identified in the Originality v. Generality Patent Analysis Test referenced above.

IP Owner's patents identified as the most valuable of the overall portfolio under the Originality v. Generality Patent Analysis Test generally received the highest scores under the Patent Strength test. It is important to note that when Pat. Nos. 1 and 2 are viewed together as authoring one central invention—as was originally contemplated by IP Owner at the time of filing and prior to the filing of divisional applications—the combined score for the invention increases significantly under the Patent Strength Test. Had the drafters of Pat. No. 2 cited additional prior art to highlight the cross-industrial origins of several of the key sub-elements of the claimed invention, its score would have been, on a standalone basis, considerably higher. The fact that with the passing of time and with the benefit of the fresh lessons learned in the EPO adjudication of the validity of another IP Owner European Patent, the EPO patent's U.S. counterpart, contained some 212 U.S. prior art citations and in excess of 230 overall references resulting in its receipt of the highest score under this test. In such circumstances, the grant of the US patent with so many prior art citations only serves to bolster the value of the patent and its defensibility, thereby creating a very strong presumption of validity.

In summary, under the Patent Strength Test, the IP Owner patent with the strongest claims is Pat. No. 6. The IP Owner patent with the strongest validity is U.S. Pat. No. 6, and IP Owner's patent with the greatest total strength is Pat. No. 6. The combination of Pat. Nos. 1 and 2 (when read together as was originally intended) yields the next strongest Patent in the IP Owner portfolio based on the above described patent test. Interpreting the raw test results and with the benefit of review of the entire portfolio of IP Owner's patents, one concludes that these three patents together form the nucleus of the central IP Owner family of patents that has given rise to a broader group of products that derive from this primary invention.

It should be noted that tests other than the Patent Strength test may be employed to validate the qualitative Originality v. Generality Patent Analysis Test. The invention is not limited to the use of the Patent Strength test for this purpose. Preferably, the different test selected is quantitative in nature.

Prior Art

The results of a prior art search for the IP Owner's patent holdings revealed no significant prior art which would impact the validity of these patents on a going-forward basis.

While IP Owner has not enforced the patents in litigation, the fact that these patents have been successfully licensed and are currently royalty bearing is strong evidence of the validity of these two fundamental IP Owner patents. The score assigned to the portfolio for the prior art criterion is 79.

Citation History

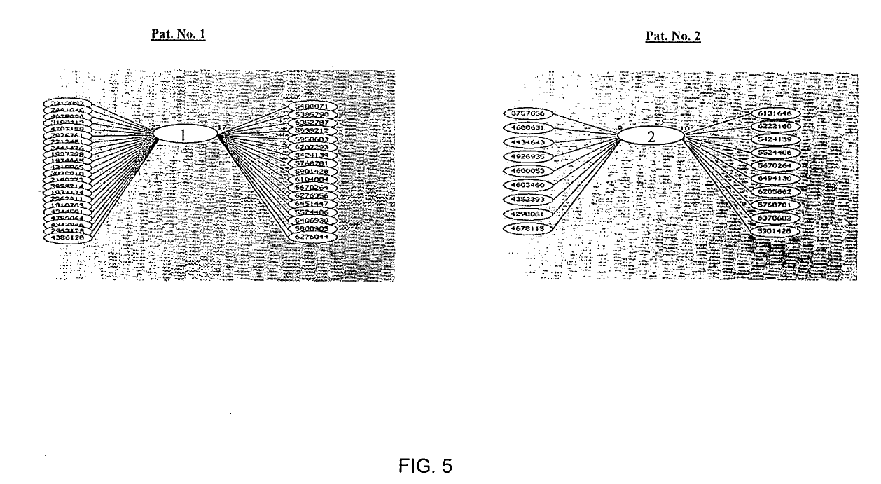

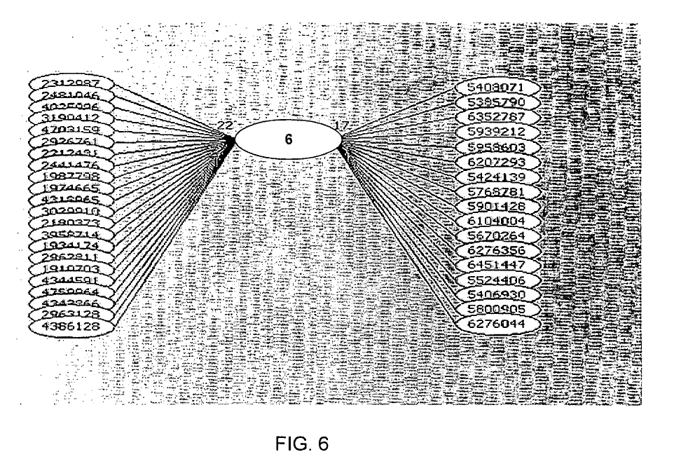

The citation review of Pat. Nos. 1 and 2 evidences significant originality (as reflected by breadth of backward citations across disciplines as represented by a diversity of SIC and NBER codes) and generality (as reflected by breadth and number of forward citations across disciplines as represented by a diversity of SIC/NBER codes associated with this forward citations). Similarly, the measures of generality and originality for other of IP Owner's key patents is strong—evidencing underlying strength of the portfolio and bearing testament to a well conceived drafting strategy. Included below in FIG. 5 and FIG. 6 are the forward and backward citation records for Pat. Nos. 1, 2, and 6. While Pat. No. 6 did not cite as many patent and non-patent prior art references as Pat. Nos. 1 and 2 did, the group taken as a whole has been well crafted and has a strong citation record. The score assigned to the portfolio for the citation history criterion is 83.

Defensible/Assertible

The ability to assert these and other patents in the portfolio will require several critical elements—(1) existence of an infringing party, (2) sufficient financial resources to be able to proceed to court in the event the assertion fails, and (3) immunity from a cross-claim of infringement from a competitor.

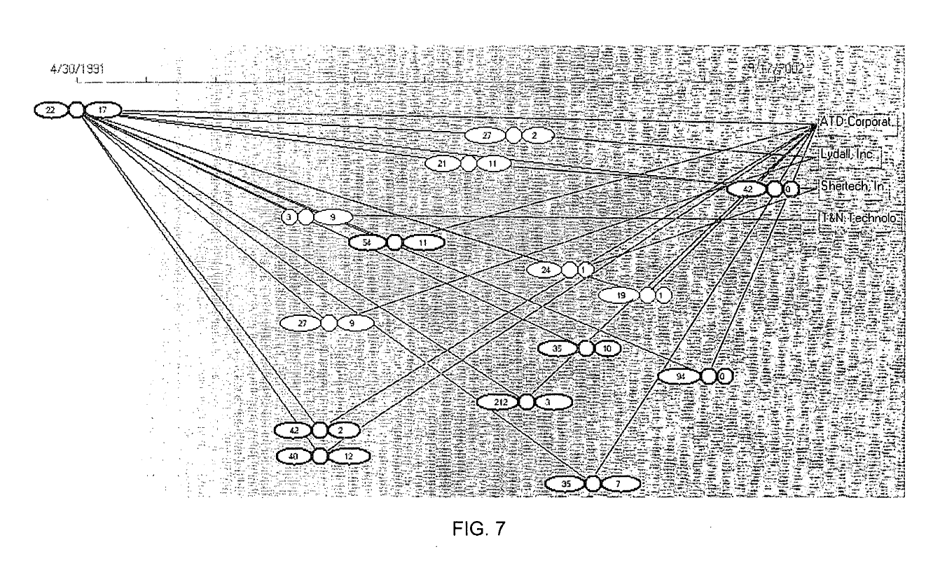

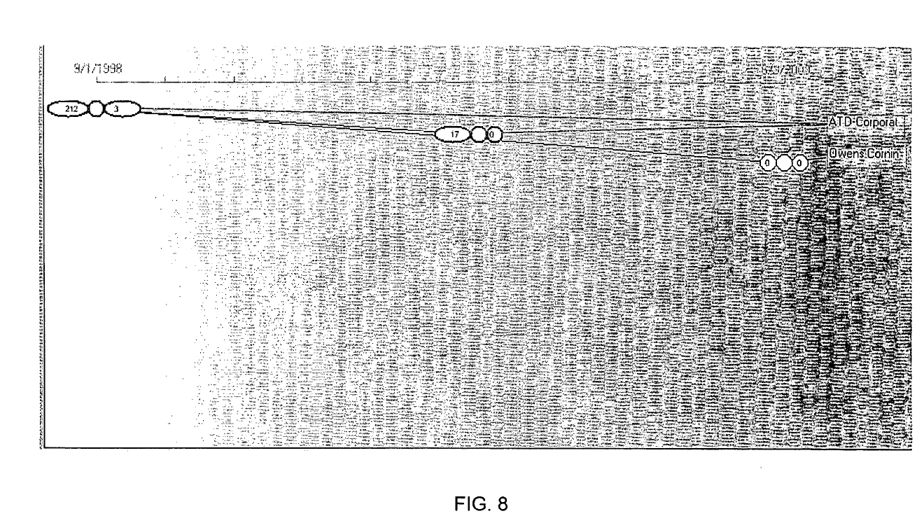

There appear to be multiple possible instantiations of products that can be architected to avoid IP Owner's patents which, coupled with IP Owner's smaller size and limited resources, lead one to the preliminary conclusion that assertions will have to be prudently carried out so as to avoid potential negative ramifications associated with costs and cross-claims. That said, the forward citation history of just the eight (8) top scoring patents highlighted in the “Originality v. Generality” test cited in FIGS. 2 and 3, above, provides evidence that several competitors or prospective competitors such as Owens Corning are active in the same arenas and, therefore, bear watching regarding potential infringement. The forward citation record of Pat. Nos. 1 and 6 are provided in FIGS. 7 and 8.

In general, as a small company attempting to compete within a litigious industry replete with examples of patent challenges and oppositions during PTO review and litigation post-issue, IP Owner's relative position in the industry and limited financial resources vis a vis some of the manufacturers of substantially similar products requires the exercise of prudence and favors so-called “carrot” assertions where possible to discourage costly work arounds and encourage a program of thoughtful licensing. The score assigned to the portfolio on this criterion is 74.

Litigation History

The history of litigation in the industry and technology space is strong, but the period in a patent's life during which it would be subject to litigation is ripe for attack is drawing to a close for several of IP Owner's key patents. Therefore, there is little perceived risk that a new round of litigation will emerge to threaten the underlying value of the portfolio. The score assigned to the portfolio for this criterion is 79.

PTO History

The history of IP Owner's patents in the US PTO evidences no significant claim scope reduction and sustains the strength of the core patents from which the overall portfolio derives its value. Given the gap in patent coverage caused by the finding of invalidity of the foreign counterpart to Patent No. 6 in Europe, IP Owner has acted to creatively license its broad technology portfolio in Europe and secure a healthy recurring revenue stream associated with royalties earned there. In addition, through direct sales of products from its German subsidiary, IP Owner has been able to compensate for any loss in rights protection in Europe and bolster overall product sales. Although the absolute protection of Pat. Nos. 1, 2, and 6 have seven years or so to expiry in the U.S., IP Owner's fundamental position in Europe is limited with respect to certain products. While IP Owner's management has compensated for this diminution in patent coverage in the region, the fact remains that a significant portion of the world's automobile producers will be able to employ inventions claimed in Pat. Nos. 1, 2, and 6 without restriction. With respect to the foreign counterparts to Pat. Nos. 5, 8, and 7, however, IP Owner's position in Europe remains strong. The score assigned to the portfolio for this criterion is 77.

Market/Externalities

Based on interviews and the available market data, it is clear that the total addressable market (TAM) for products enabled by IP Owner's patents and technology is sizable. That said, the lack of aggressive new product development and only marginal success of the marketing and sales effort to date makes it difficult to project more than a modest uptick in sales relative to historical sales and profitability. As such, the market and commercial opportunity evaluation does not reflect a significant opportunity for new licensing or sales, though the uniqueness and strength of the patents might very well support such if an appropriate level of focus and investment were made in this area.

The fact that IP Owner is not a large, deep-pocketed company with the ability to assert its patents with impunity against infringing parties, or radically transform manufacturing processes to enhance efficiency and improve profitability, or the ability to make a major thrust into the global white goods and automotive markets that it has heretofore neglected, places a cap on the value that this and others of its most valuable patents might yield. In terms of downside risks associated with externalities such as technological innovation that would accelerate obsolescence, there appear no real concerns regarding the future value of the IP. Since the pace of replacement/change of relatively low-tech embedded component technologies/products such as those enabled by IP Owner's patents is slow, it does not appear that the markets served by products are at risk of shifting and triggering a negative economic impact on product or licensing revenue. Further, the automotive and white goods industries have relatively long product/model longevity and those suppliers that supply these industries are often locked in for the entire generation/model period, so long as cost and performance can be maintained at acceptable levels. The score assigned to the portfolio on this criterion is 64.

Patent Age/Stage

Pat. Nos. 1, 2, and 6 all have 7 years remaining until expiry, so their age is not likely to be an impediment to continued value realization in terms of product sales and royalty revenue generation. That said, the history of licensing indicates that in the final years of a patent's life licensing agreements are often subject to renegotiation. Such renegotiation often results in a downward adjustment of royalties to one-half to one-quarter of current royalty rates. This impending likelihood may be coupled with the possibility that new products based on alternative approaches may threaten the patent's or family of patents' ability to continue to generate a stable and predictable recurring revenue stream through the patent/patent family's entire life. Because of the nature of the industries in which IP Owner and its licensees participate—white goods and automotive—it is less likely that alternatives will be introduced into the market prior to the patents' expiry. That said, it is important to consider the risks associated with this possibly occurring. The score assigned to the portfolio on this criterion is 81.

Licensing History

The successful history of licensing of IP Owner's Pat. Nos. 1 and 2 bears testament to the market viability and ongoing value of the products enabled by these patents. Further, the fact that minimum royalty provisions have been included in the licenses and that they generally preserve reversion rights for IP Owner in the event of sub-optimization by licensees all support the substantiation of value from the core patents. The score assigned to the portfolio on this criterion is 86.

Conclusion—Patent Portfolio Assessment

The overall score assigned to IP Owner's portfolio is 79 out of a possible 100, based upon the average of its scores for the individual categories given above. For example, one may decide that a minimum score of 70 is required for a patent portfolio to be further considered for monetization. That minimum score is met by IP Owner's portfolio here, warranting further consideration of monetization of the portfolio.

Company Assessment

In addition to the Patent Portfolio Assessment to qualitatively describe the standalone value of its intellectual property (“IP”), the financial condition of the company itself (exclusive of the valuation of the IP) should be assessed before considering making a loan to the company based on the value of its patent portfolio.

Issues to be considered may include, for example, the company's current cash position, its yearly sales and revenues figures, the relative size of the company, and the number of customers and/or industries its services.

Presuming a Patent Portfolio Assessment and Company Assessment yield satisfactory results, then the conclusion is reached that the patent portfolio is an asset (albeit an intangible one) which can serve as collateral for a loan. The next step to be taken is to determine the net present value of the patent portfolio.

Patent Portfolio Valuation

The following scenarios are designed to provide a reasonable articulation of a set of possible futures that IP Owner may experience during the next three years and a perspective on how social, economic, political, technological, legal, cultural, and market trends may impact the value of its patent portfolio during this period. As these trends are directly relevant to any assessment of current and future value of IP held by a company, it is imperative that a reasonable and well-articulated vision of plausible futures be examined to provide a framework within which to view IP Owner and its IP. Then, once developed and articulated, IP Owner's patents can be assessed and made susceptible to quantitative valuation within a relevant context.

Two valuation scenarios are presented in the example below. More valuation scenarios could hypothetically be developed, but utility of additional scenarios may be constrained by access to accurate macroeconomic data.

Valuation Scenario A—“Tight Quarters”

Scenario Description

The macroeconomy continues to labor under the strain of a post-Iraq War hangover that further depresses demand for automobiles. During the continued economic downturn, however, white goods sales rise incrementally as increasing numbers of consumers seek to reinvest in their own personal quality of life and their homes. Political conservatism continues during the period and with it comes a renewed emphasis on low interest rates and tax cuts in an effort to stimulate sales of consumer goods in the market. Technological development and the adoption rate of new technologies surprisingly accelerates the introduction of emerging technologies and applications, as there is a harvesting of the intense investment that was made in technological innovation in the latter half of the 1990's. That said, it is the new applications and technologies that offer visible forms of differentiation in electronics where much of the uptake occurs.

Automobile manufacturers place increasing focus on differentiated electronic features that permit premium pricing and margin growth in an attempt to counteract the impact of a slow growth and a stagnant economy. Similarly, the white goods space witnesses a move toward advanced electronic interfaces enabled by emerging display technology and wireless home networking to facilitate ease of use and permit items such as refrigerators to serve as data and content ‘portals’ for the family and thereby encourage more rapid turnover of products in the space. While not manifest during the period, a new trend emerges whereby white goods makers start to develop a peripherals strategy that spurs consumers to upgrade their data and content delivery components every two to three years through the purchase of ‘upgrade modules’ that are self-provisioning. Although these changes begin to gain traction during the three year period, the pace of upgrade and change out of embedded components that are not generally sufficient to serve as a source of differentiation for the customer continues to be slow.

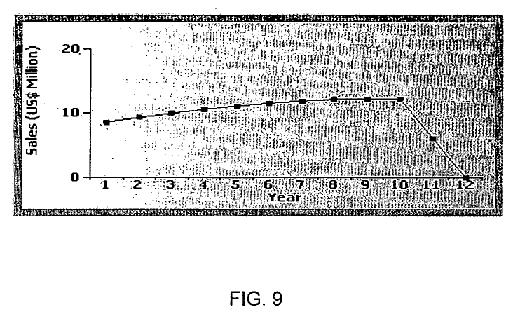

Under such a scenario, IP Owner's patents are likely to continue to retain value for current products and extension products, but the opportunity for higher than forecast growth over the next three years will be limited (an example of projected sales growth under this scenario is shown in FIG. 9). For this reason, the net present value (“NPV”) analysis for IP Owner's patents is purposefully conservative; as its fundamental patents enable the generation of revenue associated with the bulk of IP Owner's product sales and licensing revenue realization, the valuation assumes a direct correlation between the value of the patents and sales of products (by IP Owner or its licensees) enabled thereby. The key assumptions that have been made for this analysis are presented below and the NPV of the IP Owner patent portfolio is $5.81 M under the above described scenario—“Tight Quarters.” It assumes some market growth and assigns a $1.46 M portfolio value for royalty revenue, but tempers any overly ambitious views with the realities occasioned by market/industry/sector trends, historical growth, design-in cycles, continued downward price pressure on suppliers, and the effects of competition from larger players with non-infringing products that offer generally sufficient product functionality. Included below is a calculation of the NPV of the internal IP Owner products which are supported/enabled by IP Owner's patent portfolio. In addition, a NPV calculation of the value of the royalty revenue generated by licensees of IP Owner's patent portfolio is provided. The sum of these calculations equals the total assessed value of IP Owner's patent portfolio under the “Tight Quarters” Scenario as of November 2003—

$5.81 M+$1.46 M=$7.27 M

The assumptions which underlie the analysis of the NPV of IP Owner's patent portfolio insofar as it supports the company's core products and sales are as follows:

### DETAILED DESCRIPTION

| | |
|---|---|
| Weighted Average Cost of Capital | 12.0% |
| Growth Rate | 8.0% |
| Cost of Goods Sold (as a % of sales) | 68.25% |
| SG&A (as a % of sales) | 17.75% |
| R&D (as a % of sales) | 4.25% |

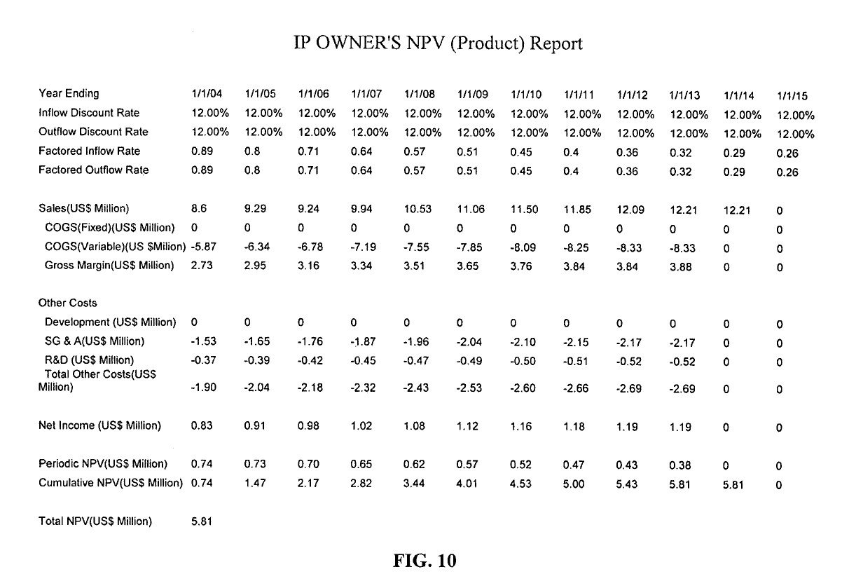

An exemplary IP Owner's NPV (product) report is shown in FIG. 10.

The assumptions which underlie the analysis of the NPV of licensing and recurring royalty revenues generated through the licensing of IP Owner's patent portfolio are as follows:

Weighted Average Cost of Capital 10.0%

Average Annual Revenue from Licensing and Royalty Realization through the Expiry of IP Owner's Base Patents—$300,000

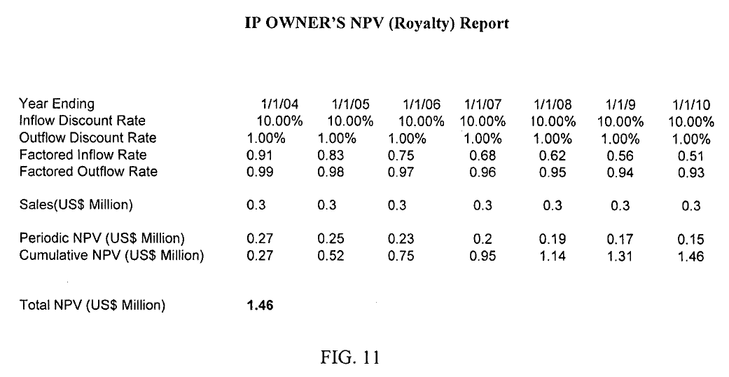

An exemplary IP Owner's NPV (Royalty) report is shown in FIG. 11.

With a valuation of $7.27 M for the patent portfolio, the lending entity may then determine how much money it might loan to IP Owner based on loan-to-value (“LTV”) ratios and/or other factors. Notably, however, this value is not so-called “book value” but a quantitative estimate of the value of IP Owner's patent portfolio based on the assumptions described above, reflecting its revenue-generating ability in net present value terms.

Further, according to the invention, this analysis is not undertaken until after a Patent Portfolio Assessment and a Company Assessment has been performed and it has been determined that the patent portfolio is a loan-worthy asset. In a preferred embodiment, the lending institution is a third party IP lender, rather than a conventional lending institution, as is described in another provisional patent application filed by the inventor, Ser. No. 60/822,606, entitled, “Method for Creating a Warehouse Loan Facility For Intellectual Property Loans.”

Valuation Scenario B—“Breakout”

Scenario Description

The macroeconomy shows signs of slow but sustainable recovery and with it comes a modest rise of consumer confidence. Long delayed home improvement projects and new car purchases are now considered and the beginnings of a revitalization are seen. During this period, white goods sales rise incrementally at first and then move into a prolonged but gradual growth phase—rise in second home sales and the increasing demand for technology-enabled applications in white goods—in particular refrigerators—rises and triggers a rise in sales of higher end white goods. The post-September 11 move toward comfort foods and comfort environments further supports this trend. Automobile manufacturers place increasing focus on differentiated electronic features that permit premium pricing and margin growth and the opportunity to take advantage of the renewed confidence found in heightened levels of consumer spending. Similarly, the white goods space witnesses a move toward advanced electronic interfaces enabled by emerging display technology and wireless home networking to facilitate ease of use and permit items such as refrigerators to serve as data and content ‘portals’ for the family and thereby encourage more rapid turnover of products in the space. The release of pent-up demand created by the uptick in the economy facilitates the emergence of a new trend where white goods makers start to develop a peripherals strategy that spurs consumers to upgrade their white goods-based data and content delivery components every two to three years through the purchase of ‘upgrade modules’ that are self-provisioning. These changes begin to gain traction during the three year period and the pace of upgrade and change out of embedded components that are not generally sufficient to serve as a source of differentiation for the customer begins to accelerate.

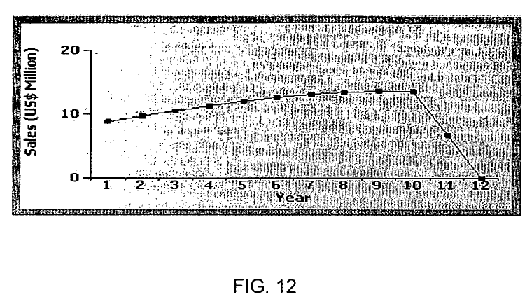

Under such a scenario, IP Owner's patents should increase in value as the number of units of end user consumer goods in which its products and those of its licensees are present increase. The opportunity for higher than forecast growth over the next three years starts to clearly manifest itself by year three and there is a sense of optimism about the future at that point (an example of projected sales growth under this scenario is shown in FIG. 12). Under this scenario, the net present value (NPV) analysis for IP Owner's patents has been revised upward from the “Tight Quarters” scenario to reflect the pursuit and implementation of a successful ‘carrot’ assertion and licensing strategy by IP OWNER. In addition, a bit more upside has been attached to the future value of the patents as the products they support and the markets in which these products sell into start to boom.

IP Owner's fundamental patents enable the generation of gradually increasing revenues during the three year scenario period but then show more significant growth; the valuation assumes a direct correlation between the value of the patents and sales of products (by IP Owner or its licensees) enabled thereby. The key assumptions that have been made for this analysis are presented below and the NPV of IP Owner's patent portfolio is $9.47 M under the above described scenario—“Breakout.” In addition, it assigns a $2.77 M portfolio value for royalty revenue, assumes real market growth, but also recognizes that revenue opportunities will build over time as consumer confidence is restored and internal marketing and market expansion efforts give rise to an unprecedented level of annualized growth. The realities occasioned by market/industry/sector trends, historical growth, design-in cycles, continued downward price pressure on suppliers, and the effects of competition from larger players with non-infringing products that offer generally sufficient product functionality of course remain at the forefront of one's thoughts in preparing this valuation, but recognition is given to the impact of restored consumer confidence and the success of its marketing and new market entry initiatives on the value of IP Owner's patents. Further, under this scenario there is a tacit acceptance that over time IP Owner will be able to use the uptick in the market and much needed access to additional working capital to improve internal processes, enhance manufacturing efficiencies, improve profitability, and focus increased attention on ‘carrot’ assertions of its core patents and license its emerging inventions more aggressively.

Included below is a calculation of the NPV of the internal IP Owner products which are supported/enabled by the IP Owner patent portfolio. In addition, a NPV calculation of the value of the royalty revenue generated by licensees of IP Owner's patent portfolio is provided. The sum of these calculations equals the total assessed value of the IP Owner patent portfolio under the “Breakout” Scenario as of November 2003

$9.47 M+$2.27 M=$11.74 M

Given a value of $11.74 M for the patent portfolio, the lending entity may then determine how much money it might loan to IP Owner based on loan-to-value (“LTV”) ratios and/or other factors. Notably, however, this value is not so-called “book value” but a quantitative estimate of the value of IP Owner's patent portfolio based on the assumptions described above, reflecting its revenue-generating ability in net present value terms. Further, according to the invention, this analysis is not undertaken until after a Patent Portfolio Assessment and a Company Assessment has been performed and it has been determined that the patent portfolio is a loan-worthy asset. In a preferred embodiment, the lending institution is a third party IP lender, rather than a conventional lending institution, as is described in another provisional patent application filed by the inventor, Ser. No. 60/822,606, entitled, “Method for Creating a Warehouse Loan Facility For Intellectual Property Loans.”

The assumptions which underlie the analysis of the NPV of IP Owner's patent portfolio insofar as it supports the company's core products and sales are as follows:

| | |
|---|---|
| Weighted Average Cost of Capital | 12.0% |
| Growth Rate | 10.0% |
| Cost of Goods Sold (as a % of sales) | 66.22% |
| SG&A (as a % of sales) | 15.0% |
| R&D (as a % of sales) | 4.0% |

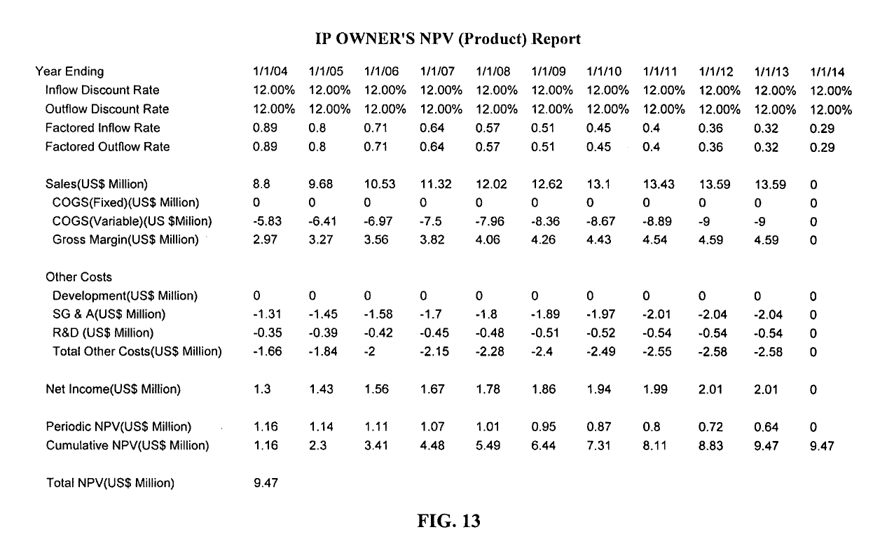

An exemplary IP Owner's NPV (product) report is shown in FIG. 13.

The assumptions which underlie the analysis of the NPV of licensing and recurring royalty revenues generated through the licensing of IP Owner's patent portfolio are as follows:

Weighted Average Cost of Capital 10.0%

Average Annual Revenue from Licensing and Royalty Realization through the Expiry of IP Owner's Base Thermsulate 5000 Patents—$466,000

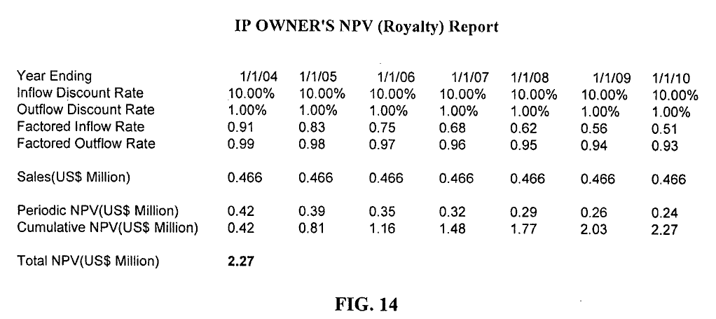

An exemplary IP Owner's NPV (royalty) report is shown in FIG. 14.

Although the present invention has been described in terms of the presently preferred embodiments, it is to be understood that the disclosure is not to be interpreted as limiting. Various alterations and modifications will no doubt become apparent to those skilled in the art after having read this disclosure. Accordingly, it is intended that the appended claims be interpreted as covering all alterations and modifications as fall within the spirit and scope of the invention.

### APPENDIX A

### Bases for Calculations in FIG. 4

Claims Strength is based on the sum of the breadth of the claims×0.5, the number of independent claims×0.3, and the total number of claims×0.2 or CS=0.5B+0.3I+0.2N. The breadth of the claims includes a score of 1 for independent claims with many elements that only cover one aspect of the invention, a score of 3 for independent claims with a number of elements that cover a number of aspects of the invention, and a score of 5 for independent claims with very few elements that cover many aspects of the invention. The greater the sum, the stronger the claims are.

Validity Strength is based on Cited References for the patent and more specifically on the sum of the number of U.S. and Foreign Non-Patent Documents×0.5, the number of U.S. Patent Documents×0.25, and the number of Foreign Patent Documents×0.25 or VS=0.5N+0.25U+0.25F. The greater the sum, the stronger the validity of the patent.

Total Strength is the sum of the Claims Strength and the Validity Strength.

### APPENDIX B

### Calculations supporting results in FIG. 4

U.S. Pat. No. 6,586,111

CS=3(0.5)+5(0.3)+23(0.2)=7.6

VS=1(0.5)+18(0.25)+3(0.25)=5.75

TS=13.35

U.S. Pat. No. 6,451,447

CS=3(0.5)+2(0.3)+17(0.2)5.5

VS=0+42(0.25)+4(0.25)=11.5

TS=16

U.S. Pat. No. 6,391,469

CS=3(0.5)+3(0.3)+20(0.2)=6.4

VS=1(0.5)+12(0.25)+0=3.5

TS=9.9

U.S. Pat. No. 6,337,143

CS=3(0.5)+2(0.3)+10(0.2)=4.1

VS=0+4(0.25)+0=1

TS=5.1

U.S. Pat. No. 6,276,356

CS=3(0.5)+5(0.3)+22(0.2)=7.4

VS=0+94(0.25)+19(0.25)=28.25

TS=35.65

U.S. Pat. No. 6,276,044

CS=1(0.5)+1(0.3)+10(0.2)=2.8

VS=0+36(0.25)+4(0.25)=10

TS=12.8

U.S. Pat. No. 6,222,160

CS=3(0.5)+2(0.3)+12(0.2)=4.5

VS=0+17(0.25)+1(0.25)=4.5

TS=9.0

U.S. Pat. No. 6,207,293

CS=3(0.5)+5(0.3)+25(0.2)=8

VS=0+36(0.25)+6(0.25)=10.5

TS=18.5

U.S. Pat. No. 6,104,004

CS=3(0.5)+4(0.3)+21(0.2)=6.9

VS=0+19(0.25)+8(0.25)=6.75

TS=13.65

U.S. Pat. No. 6,036,997

CS=3(0.5)+3(0.3)+12(0.2)=4.8

VS=0+45(0.25)+16(0.25)15.25

TS=20.05

U.S. Pat. No. 6,012,493

CS=5(0.5)+6(0.3)+29(0.2)=10.1

VS=0+20(0.25)+0=5

TS=15.1

U.S. Pat. No. 5,958,603

CS=5(0.5)+9(0.3)+37(0.2)=11.7

VS=0+35(0.25)+4(0.25)=9.75

TS=21.45

U.S. Pat. No. 5,939,212

CS=5(0.5)+7(0.3)+35(0.2)=11.6

VS=0+35(0.25)+6(0.25)=10.5

TS=22.1

U.S. Pat. No. 5,845,805

CS=3(0.5)+5(0.3)+13(0.2)=5.6

VS=0+8(0.25)+0=2

TS=7.6

U.S. Pat. No. 5,800,905

CS=3(0.5)+5(0.3)+75(0.2)=18

VS=30(0.5)+212(0.25)+54(0.25)=81.5

TS=99.5

U.S. Pat. No. 5,767,024

CS=1(0.5)+1(0.3)+30(0.2)=6.8

VS=0+9(0.25)+0=2.25

TS=9.05

U.S. Pat. No. 5,658,634

CS=1(0.5)+3(0.3)+12(0.2)=3.8

VS=0+71(0.25)+3(0.25)=18.5

TS=22.3

U.S. Pat. No. 5,633,064

CS=1(0.5)+1(0.3)+12(0.2)=3.2

VS=0+72(0.25)+5(0.25)=19.25

TS=22.45

U.S. Pat. No. 5,524,406

CS=3(0.5)+5(0.3)+36(0.2)=10.2

VS=2(0.5)+54(0.25)+5(0.25)=15.75

TS=25.95

U.S. Pat. No. 5,503,927

CS=5(0.5)+3(0.3)+13(0.2)=6

VS=1(0.5)+50(0.25)+19(0.25)=17.75

TS=23.75

U.S. Pat. No. 5,408,071

CS=3(0.5)+3(0.3)+31(0.2)=8.6

VS=0+40(0.25)+5(0.25)=11.25

TS=19.85

U.S. Pat. No. 5,406,930

CS=1(0.5)+1(0.3)+3(0.2)=4.8

VS=0+42(0.25)+5(0.25)=11.75

TS=16.55

U.S. Pat. No. 5,111,577

CS=1(0.5)+2(0.3)+19(0.2)=4.9

VS=0+9(0.25)+0=2.25

TS=7.15

U.S. Pat. No. 5,011,743

CS=1(0.5)+2(0.3)+31(0.2)=7.3

VS=0+22(0.25)+2(0.25)=6

TS=13.3

What is claimed is:

1. A method of monetizing a patent portfolio, comprising:
performing an assessment of patents in the patent portfolio to determine whether the patent portfolio is a loan-worthy asset; and
if the patent portfolio is determined to be a loan-worthy asset, valuating the patent portfolio to assign a monetary value to the patent portfolio.

2. The method of claim 1, further comprising issuing a loan using the patent portfolio as collateral based on the monetary value.
